(19) United States
(12) Patent Application Publication
(10) Pub. No.: US 2025/0262870 A1
(43) Pub. Date: Aug. 21, 2025

(54) PROCESSING STATION

(71) Applicant: WIPOTEC GmbH, Kaiserslautern (DE)

(72) Inventor: Daniel ANDERS, Osthofen (DE)

(21) Appl. No.: 19/058,770

(22) Filed: Feb. 20, 2025

(30) Foreign Application Priority Data
Feb. 20, 2024 (DE) 102024104706.2

(51) Int. Cl. B41J 3/407; B41F 33/00

(52) U.S. Cl. CPC B41J 3/40731; B41F 33/0036

(57) ABSTRACT

The invention relates to a device and a method for transporting and processing products, wherein a processing unit that processes the products, comprising a conveyor unit, a processing means, and an associated auxillary means, can be displaced relative to a fixed base body in the transverse direction to the conveying direction in order to be able to receive the products fed to the processing unit at a predetermined transverse position.

The present invention relates to a processing station for conveying and processing discrete products that are transported along a process line. Often, a large number of similar products (production lot, hereinafter also referred to as batch) are processed in a single processing run before the type of product or the required processing changes.

For processing the products, various processing means are known which interact with the product during the processing. This may be, for example, a reading unit for capturing product labels. Also conceivable are inspection units which examine the product for certain properties. Moreover, the application of markings on the product is also one of such processing operations. Often the products are moved into the range of action of the processing means by means of a conveyor unit, for example a conveyor belt or a comparable means of transport, in a conveying direction X, and often a special alignment or positioning of the product relative to the processing means is required for successful processing.

For example, it would be conceivable to move and/or align the print head of a printing unit relative to the product, in particular transversely to the conveying direction X, towards the product in such a way that the printing process can be carried out with a desired Y-distance between the product and the print head. Alternatively, a product that is initially positioned in an arbitrary position could be aligned—for example, as it is coming from the conveyor belt of a feed unit—with a stationary print head by first being diverted and/or aligned along a rerouting section onto a track running along the print head in order to then reach the processing means in a position or alignment that is optimal for processing.

However, these measures could become difficult if, for example, the print head cannot be freely moved in a transverse direction Y orthogonal to the conveying direction X because its movement is blocked, for example, by the conveyor belt. On the other hand, a re-routing section requires additional and precious space along the conveying path of the process line. Furthermore, an auxiliary means is often required that interacts with the processing means in a specific manner as the product is being processed. This auxiliary means must likewise often assume a certain position relative to the product during processing, which makes the correct positioning of the product, processing means and auxiliary means even more difficult.

From DE102009048442A1, a control system is known which comprises a central control unit connected to several sensors in order to capture process parameters in real time. The system integrates actuators that are controlled by the control unit based on the collected data in order to optimize the functionality of an industrial process. The design enables precise adjustment and control, with a focus on increasing efficiency and flexibility.

DE 93 04 387 U1 describes a conditioning device with a treatment chamber consisting of a base body and a holding device attached to it. The holding device is designed to enable the object to be treated to be held securely. An integrated locking mechanism is used to fix the object in the treatment chamber and to ensure precise alignment. The design of the device is intended to provide both stability and ease of use, as well as being suitable for easy assembly and maintenance.

JP S63-107 592 U1 describes a workpiece handling device that consists of a base plate as a base, a support column vertically mounted on the base plate for structural support, a rotary arm attached to the support column for rotating the workpiece, and a gripper mechanism at the end of the rotary arm for grasping and holding the workpiece. A drive unit controls the movement of the rotating arm and the gripper mechanism. This configuration enables precise positioning and efficient handling of workpieces in industrial applications.

An appliance is known from KR 20 0 206 740 Y1, which comprises a device with a base structure on which a holding device is mounted. This holding device is used to hold a workpiece or an object in a stable position. In addition, the device includes a control mechanism that allows for precise adjustments of the holding device. The aim is to ensure improved handling and positioning of the workpiece, with the design being geared towards simple operation and versatility.

It was therefore an object of the invention to provide a processing station that overcomes the aforementioned disadvantages. The object is achieved by a processing station according to claim 1 and a method according to claim 9. Further advantageous embodiments emerge from the subclaims.

The invention is based on the finding that a product can be positioned relative to the processing means for its upcoming processing by using a design in which the processing means, together with the auxiliary means and the conveyor unit, form part of a processing unit and, as such, can be displaced together in the transverse direction Y. According to the invention, it is thus possible to move the processing unit or, respectively, its conveyor unit to a Y-position that is pre-settable for successful processing before a product that is to be processed reaches the conveyor unit. By skillfully selecting the Y-position, the product reaches the conveyor unit at an optimal transverse position for the subsequent processing.

The processing unit is part of a processing station according to the invention, which is designed to convey and process discrete products in a product stream, and which, for this purpose, extends in a conveying direction X, a transverse direction Y that runs orthogonally, usually horizontally, thereto, and a-usually vertical-height direction Z that runs orthogonally to the conveying direction and the transverse direction. The processing station includes a base body that is arranged in a fixed location during regular operation, for example a machine frame arranged on a hall floor, which is designed to receive and fix in place various components of the processing station.

The processing station has a processing unit, which in turn has a conveyor unit, at least one processing means, and at least one auxiliary means associated with the processing means. The conveyor unit is designed to transport products in the conveying direction X along e conveying plane formed by the conveyor unit. For example, the top side of a conveyor unit's conveyor belt, which is assumed to be flat, can form the conveying plane.

The processing means is designed to process a product while it is being conveyed or temporarily stopped by the conveyor unit. In particular, this refers to processing means where a predetermined distance between the processing means and the product is required for the processing.

In the broadest sense, “processing” is to be understood as any deliberately induced interaction between the product and the processing means that serves to create, modify or capture a property of the product. Even a marking on the product should be understood here as a property of the product, so that reading an existing marking or applying a new marking on the product corresponds to the capture or creation of a product property. Other forms of processing to be understood as the capture of a product property including inspecting the product with a camera, for example to obtain information about certain product features by means of image analysis, or examining the product using X-rays to determine its radiographic properties and, for example, detect foreign bodies in the product, determine layer thicknesses or fill quantities, or carry out completeness and leak tests. By contrast, the mere existence or alignment of a product at a certain position on the conveying plane that could, for example, be detected by means of a sensor, should not be understood as a property within the meaning of the above definition. For example, in the case of a light barrier, the distance between the product and the sensor is usually insignificant. Similarly, a sensor that works, for example, inductively or capacitively, which, despite certain distance requirements, is used solely to detect a product, should not be understood as a means of capturing a property of the product.

The auxiliary means associated with a particular processing means serves to support or even enable the processing of the product by the processing means. This auxiliary means could, for example, be a guide element which aligns or guides the product during processing. In particular, the guide element could serve to stabilize the product against movement in the transverse direction Y while, for example, a marking is applied to it by the processing means. This may take the form of attaching a label or printing a marking on the product, preferably on the side of the product facing away from the guide element. The guide element ensures that during the marking process, the product is guided along the processing means at a predetermined-preferably small-Y-distance in order to be able to apply a high-quality marking to the product.

Other conceivable embodiments include embodiments in which more than one processing means is provided. For example, the processing unit could comprise both a printing unit and a camera. Furthermore, it is also conceivable that the processing unit comprises a plurality of auxiliary elements, wherein the plurality of auxiliary elements may be associated with different processing means or with only one processing means. For example, the guide element described above could be used to guide a product in the transverse direction Y during both a marking process and a subsequent or preceding inspection with a camera, for example in order to ensure that the product does not leave the camera's focusing range during processing.

Alternatively, a first auxiliary element could be used to merely guide the product during a marking process, while a second auxiliary element that is designed as a light protection or lighting device supports or optimizes image capture by a camera. The two auxiliary elements would then be associated with different processing means.

According to the invention, the at least one processing means and the at least one auxiliary means associated with it each extend at least partially above the conveying plane, thereby enabling or facilitating the processing of the product. According to a preferred embodiment, the at least one processing means extends at least partially below the conveyor unit or the conveying plane in such a way that the conveyor unit blocks a free displacement of the processing means in the transverse direction Y, in particular in the direction of a product P arranged on the conveying plane.

According to the Invention, the at least one processing means and the at least one auxiliary element associated with it for the processing of the product are fixed to the processing unit on two sides of the product lying opposite one another in the transverse direction Y.

The processing means and the associated auxiliary element therefore receive the product between them during processing, with the processing means on one side and the associated auxiliary element on the opposite side of the product interacting with each other in order to properly perform the processing.

The core of the invention is to design the processing means and the auxiliary element assigned thereto such that they can be moved together with the conveyor unit relative to the stationary base body in the transverse direction Y. According to the invention, the relative movement serves to pick up a product to be fed to the processing unit at a pre-settable Y-position of the conveying plane, in order to subsequently convey and process it between the auxiliary element and the processing means.

The joint displaceability of the processing means, auxiliary means, and conveyor unit allows advantageously for particularly flexible adaptation to different product sizes and feed positions of the products in relation to the transverse direction Y Thus, the processing unit is able to receive products to be fed to it at a selectable Y-position or, respectively, to pick them up on the conveying plane of the conveyor unit at a selectable Y-position, as will also become clear from the examples in the figures. The position of the processing means relative to the conveyor unit does not have to be changed (i.e. readjusted) for this purpose. The auxiliary means likewise maintains its position relative to the conveyor unit or, respectively, the processing unit, while all three units can be moved together, i.e. in a rigid position in relation to one another, in the transverse direction Y in order to move them to the required Y-position in order to receive the product to be fed to the conveyor unit.

However, the joint displacement does not preclude the processing unit from being prepared beforehand for the processing of a specific product type, which is to be processed, for example, as a batch or in a larger quantity. Then it may be necessary to first adjust the auxiliary means and/or the processing means and to position and fix it relative to the conveyor unit in the transverse direction Y for this purpose. For example, a guide element serving as an auxiliary means and/or a printing unit serving as a processing means could first be adjusted to the width of the products to be printed on by moving it transversely into the corresponding position and then fixing it in that position 30 before the start of a processing run. Knowing the transverse position at which the products are fed to the conveyor unit (transfer position), the processing unit can then be moved relative to the base body in the transverse direction Y in such a way that the transferred products are precisely guided past the print head of the printing unit with a side to be printed on, while the products are guided and stabilized on the opposite side by means of the previously positioned and fixed guide element. For all further products of the same type being fed in, it is neither necessary to perform a new transverse displacement of the entire processing unit nor to readjust the relative positions of the processing means, auxiliary means and conveyor unit to one another.

According to an advantageous embodiment of the invention, the processing station comprises a feed unit arranged upstream of the processing unit, which is designed to feed the products to the conveyor unit. The feed unit can have a conveyor belt or a comparable conveying means, on which the products are conveyed in the conveying direction X to the conveyor unit and transferred to it. The inventive displaceability of the processing unit relative to the feed unit makes it possible to transfer the product in a straight line or track in the conveying direction X from the feed unit to the conveyor unit at a selectable Y-position, without the product as such needing to change track or be moved laterally on the feed unit or the conveyor unit for the subsequent processing.

Unlike the processing unit, the feed unit can be stationary and attached to the base body of the processing station, for example. A transverse displacement of the feed unit in the Y-direction is, moreover, neither necessary nor useful for realizing the principle underlying the invention, since a kinematic reversal of the inventive device (i.e. with a stationary processing unit and a laterally displaceable feed unit) cannot solve the problem underlying the invention. This is because the feed unit would then have to reposition each individual product conveyed on it for the downstream processing unit by individually displacing it transversally, which would severely limit the conveying capacity of the feed unit and require permanent traversing movements.

Instead, the processing unit can be moved relative to the feed unit in the transverse direction Y in such a way that a product coming from the feed unit is transferred, at a selectable Y-position, from the latter to the conveyor unit or, respectively, to the conveying plane formed by it.

According to an advantageous embodiment of the invention, the processing unit is carried by a guide, in particular a linear guide, which in turn is connected to the base body. For example, the guide can have a lower section connected to the base body and an upper section in the form of a carriage that can be moved in the transverse direction Y relative to the lower section and that is connected to the processing unit. The guide can be operated manually, for example by an operator appropriately moving the carriage in the transverse direction before the start of a processing cycle and fixing it in this position. Alternatively, the guide could also have a drive and be operated automatically, for example with the aid of a control unit which automatically sets the transverse position to which the carriage needs to be moved based on the products to be processed and the type of processing.

The processing means can, for example, be designed as a printing unit. The printing unit can, for example, be designed to print an identification marking on a product on a side surface rising from the conveying plane. It is also conceivable that the marking is to be applied only just above the conveying plane, so that the print head is also arranged only just above the conveying plane. For this purpose, it may be necessary to locate the printing unit at the edge of the conveying plane so that parts of the printing unit can also extend below the conveying plane. In this case, the processing unit could be positioned in the transverse direction Y relative to an upstream feed unit in such a way that the products are transferred from the feed unit to the processing unit exactly at the edge of the conveying plane or, respectively, at the edge of the conveyor unit's conveyor belt. To achieve this, an auxiliary element designed as a guide element would be adjusted and fixed along the processing unit in accordance with the product width such that the product is conveyed lying on the edge of the conveyor belt and as close and non-rotatably as possible past the print head and the guide element or, respectively, between the print head and the guide element. Like any other processing, the application of a marking or print, for example by means of an inkjet printer, can be done while the product is being conveyed by the conveyor unit or while the conveyor is briefly halted.

The processing means may also be designed as an inspection unit. This should also include means that detect a marking affixed to the product, or certain design features, or product dimensions. Such means include, for example, cameras, RFID sensors, or barcode or QR code scanners. Likewise, an X-ray device for detecting certain product or radiographic properties, e.g. for determining inhomogeneities or foreign bodies in the product, for fill level measurement or optical transmitted-light inspection such as sealed seam inspection, should also be included in the group of inspection units. In the case of an X-ray inspection, the operating means would then be, for example, a scintillator or another X-ray-detecting sensor or detector, while an X-ray source could serve as an associated auxiliary means. The two components could then be located opposite each other in the transverse direction Y and inspect a product passing between them on the conveyor (“side view”).

Another example of a processing means is an ejector that can selectively eject individual products from the conveying stream. In particular, this can be a diverting element that can be pivoted or displaced above the conveying plane, which applies a lateral force, in particular a sudden sideways bump, to a product in order to move the product off the conveying plane. As an associated auxiliary element, a deflecting element could be provided that, in a targeted manner, diverts the products bumped by the steering element off the conveying plane, for example into a container arranged next to the conveyor unit.

In one advantageous embodiment of the invention, the auxiliary element is designed as a guide element in order to guide a product conveyed on the conveying plane laterally (in the transverse direction Y). For this purpose, the guide element has a guide face along which the product can slide, or against which it can rest in the event of a temporary belt stoppage. The guide face can also serve to prevent the product from rotating or shifting on the conveying plane. Preferably, the guide face extends in the conveying direction X. It is also preferable for the guide face to be even. Most preferably: the guide face extends in an X-Z plane, A guide element can be useful for various processing means that require the product to be guided during processing. This includes the application of markings, in particular on a product side opposite the guide face, and especially in situations where, as part of the processing (e.g. during labeling), a force in the transverse direction Y is exerted on the product, which is absorbed and compensated by the guide element. The guide element can also prevent a product that is to be inspected by image recognition means from changing its position in the transverse direction Y during processing, in order to enable a correct capturing of the image data and to, for example, hold the product in the focusing area of a camera.

Alternatively or additionally, the auxiliary element can also be designed as a light shield, as a backlight, as protection against electromagnetic radiation, as a wind shield, as a reflective means, as an illumination means, or as another component that is directly associated with the respective processing means and specifically intended to enable or facilitate the processing of the product with the respective processing means.

According to a further embodiment of the invention, it is also conceivable that an auxiliary means is designed as a further processing means. For example, two cameras located opposite each other could capture a product from two sides, or a product is printed on on one side while a camera on the opposite side interacts with the product to capture images. It is also conceivable to apply two markings, for example on two opposite sides of the product, using two printing units, whereby an auxiliary element serving as a guide element for one printing unit is at the same time part of the opposite printing unit. It is also conceivable to use two cameras on sides lying opposite each other in the transverse direction Y, whereby a guide element serving as an auxiliary element for the first camera could at the same time carry the second camera. The second camera could also capture features on the upper side of the product facing away from the conveying plane.

Preferably, the at least one processing means and/or the at least one auxiliary means is manually or automatically adjustable and fixable in the transverse direction Y and/or in the height direction Z. This allows the processing unit to be adjusted to products with different dimensions and to different processing requirements. For example, the height position of a marking to be applied on the product can be set by fixing a processing means in the form of a printer at a height required for this purpose.

The inventive processing station as such is stationary and has, for example, a common frame as a base body, to which the processing unit can be attached in a movable manner and a feed unit in a stationary manner. The processing unit that can be moved in the transverse direction Y relative to the base body is preferably limited, in as much as possible, to those components (at least one processing means, one conveyor unit, and at least one auxiliary means) that are necessary to realize the principle of transverse displacement underlying the invention. Other typical machine components—such as a housing that protects the processing station as a whole or in part, an associated control cabinet, a control unit, an operating terminal, or a display unit—can, by contrast, preferably be stationary and connected to the base body, since a transverse displacement of these components is not directly required to realize the inventive idea, and this results in smaller amounts of masses needing to be displaced.

The conveyor unit of the processing unit can fulfill the requirements for implementing the invention, provided that it is able to convey a product to be processed between the processing means and the auxiliary means. Preferably, this is a conveyor belt with a continuous belt surface. Alternatively, and depending on the products to be conveyed, other conveying devices or principles may also be used. For example, a multi-belt conveyor with several parallel straps, a roller conveyor, or a chain conveyor could also 20 be used, as long as the proper transport of the products and the lateral displaceability of the processing unit do not adversely affect the implementation of the invention as a result of the conveying principle. Likewise, a feed unit can be realized by means of various transport devices known to those skilled in the art, as long as it can transfer the products to the conveyor unit.

A processing station according to the invention can comprise an additional conveying component arranged above the conveying plane, which supports the conveying of the product. Thus, another conveyor unit could be arranged above the conveyor unit, so that the product can be transported clamped by the upper and lower conveyor unit.

In this case, the upper conveyor unit, which can also be referred to as an upper conveyor, is then likewise part of the processing unit and displaceable in the transverse direction Y together with the lower conveyor unit, the processing means, and the auxiliary means. Moreover, the upper conveyor can itself be transversely displaceable and fixable relative to the processing unit and/or the base body in order to align it for certain product types. In addition, the upper conveyor can carry further processing means, for example a printer intended preferably for the top side of the products, a camera, etc. If the upper conveyor or means attached to it support processing by another processing means, it can also be understood as an auxiliary means in the broadest sense.

A method according to the invention uses a processing station as described above together with a feed unit and comprises the following steps:
10) Positioning of the processing unit in the transverse direction relative to the feed unit based on the position in which the product is to be placed on the feed unit at the moment of transfer to the conveyor unit;
20) Conveying of at least one product by means of the feed unit and automatically transferring the product to the conveyor unit of the processing unit, with subsequent conveying of the product in the conveying direction X and processing of the product by the processing means and the auxiliary means associated therewith.

After carrying out method step: 10), method step 20) can be repeated immediately for each subsequent product of the same type or, respectively, for the same processing, without each time requiring a new adjustment or transverse displacement according to method step 10). It is assumed that each product is transported by the feed unit always at the same transverse position in order to reach the conveying plane at the same transfer position that was the basis for the adjustment according to method step b).

In preparation for product processing, it may be expedient, according to one embodiment of the method, to precede method step 10) with the following step:
05) Positioning of the at least one processing means and of the auxiliary means associated therewith in the transverse direction Y relative to the conveyor unit in accordance with the product to be conveyed, in particular setting a distance in the transverse direction Y between the at least one processing means and the auxiliary means associated therewith.

This ensures that the distance from the processing means and/or the auxiliary means to the product and/or between the processing means and the product is set for the subsequent processing. Performing this step just once can be sufficient for a batch of similar products, and, depending on the provision of the products, this step could also be switched with method step 10).

A preferred embodiment of the method is directed at the use of a guide element as an auxiliary element whose guide face extends substantially in the conveying direction X. In this case, method steps 05 and/or 10) are carried out with the provision that
i) when the product is transferred from the feed unit to the conveying plane, a section of a first outer surface of the product is aligned with the guide face, so that the product, after having been transferred to the processing unit, is guided laterally by the guide element,
and/or
ii) after the product has been transferred to the processing unit, a section of a second outer surface of the product occupies a predeterminable Y-position on the conveying plane as required for the processing with the processing means.

For example, for the purpose of laterally printing on a product with the support of a guide element, a distance You can first be set between the guide face of the guide element and the processing means (for example a print head), which distance essentially corresponds to the width of the product to be processed in the transverse direction Y, in order to ensure precise and close guidance of a first side of the product along the print head. The setting can be made, for example, by moving the guide element in the transverse direction Y to the said distance from the print head and fixing it in this position on the processing unit. The print head then does not also have to be moved and could even be permanently fixed to the processing unit, for example. The processing means “print head”, the feed unit, and the auxiliary means “guide element” are arranged rigidly relative to one another and, forming part of the processing unit, they can be displaced together in the transverse direction Y and relative to the base body.

The processing unit can then be positioned relative to the feed unit in such a way that the product to be taken over from the feed unit is conveyed onwards in such a way that a second side lying opposite the first side in the transverse direction Y is guided closely past the printhead in order to be able to produce a high-quality print image on this second side. In this particular application (printing), method steps i) and ii) are employed to precisely adjust the processing station to the product width and the feed position of the product. Likewise, when inspecting the product, for example by means of a camera, the displacement of the processing unit allows for the products to be taken over onto the conveying plane exactly at the Y-position at which the products, while being conveyed onwards by means of the conveyor unit, are led through the focusing area of the camera.

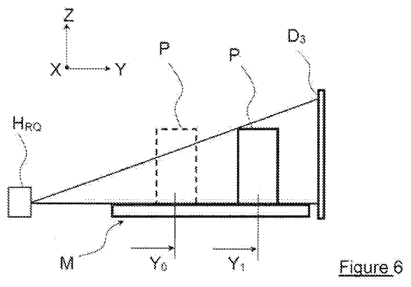

In the case of an X-ray inspection, the product should preferably be placed such that all the rays emanating from the X-ray source are directed at the product and radiograph the product over its entire vertical dimension. In addition, the X-ray source and the X-ray detector should preferably be positioned relative to each other in such a manner that the rays passing through the product, which, as a rule, emanate from the X-ray source in a fan-shaped pattern, make best use of the size of the X-ray detector located behind the product. FIG. 6 illustrates this.

In the aforementioned processing cases, which are comparable in terms of their positioning requirements, the product can then be transferred from the feed unit to the conveyor unit in a straight line and processed there.

In the following, an embodiment of the invention is explained in more detail using the examples in the figures, which show the following:

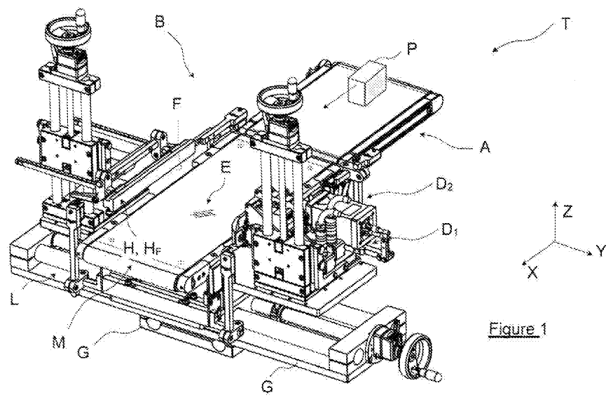

FIG. 1 shows a perspective view of a first embodiment of the invention;

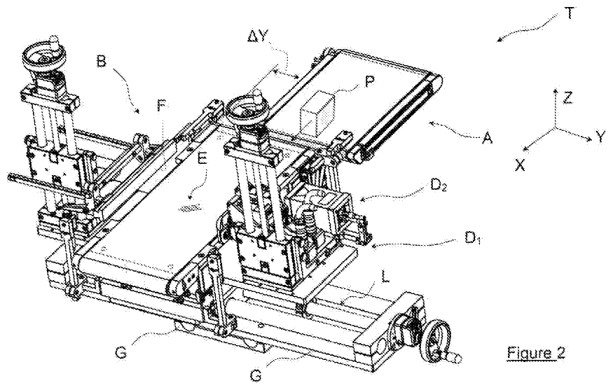

FIG. 2 shows the embodiment according to FIG. 2 after transverse displacement of the processing unit;

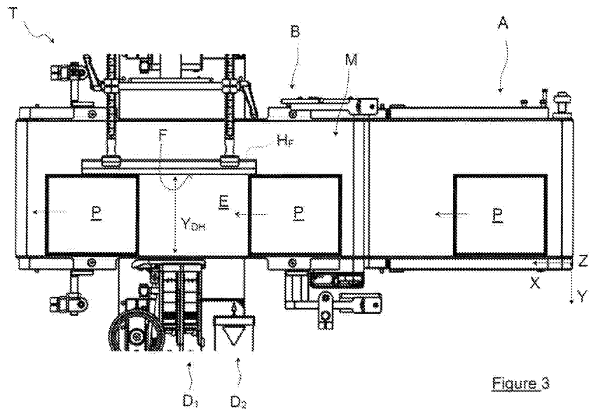

FIG. 3 shows a simplified top view of the device according to FIG. 1;

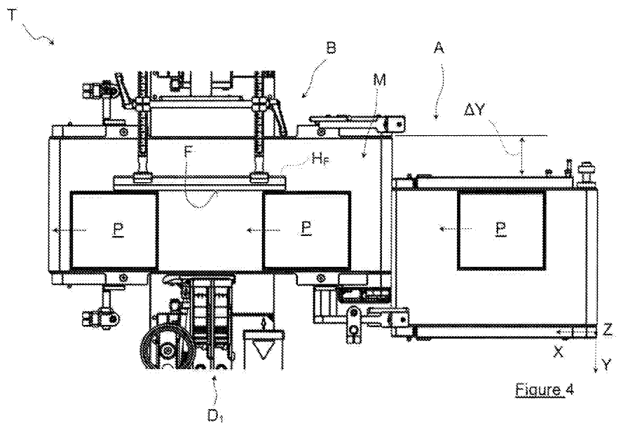

FIG. 4 shows a simplified top view of the device according to FIG. 2;

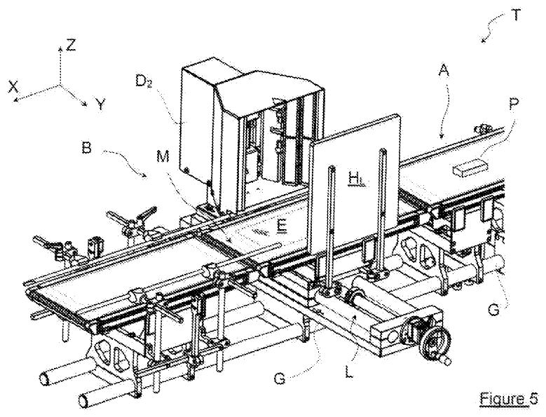

FIG. 5 shows a perspective iew of a second embodiment of the invention; and

FIG. 6 shows a schematic representation of the X-ray radiography of a product.

FIG. 1 shows, in a simplified perspective view, a processing station T according to the invention, which extends in a horizontal conveying direction X, a horizontal transverse direction Y orthogonal thereto, and a height direction Z orthogonal to both directions.

The processing station T is arranged on an only partially shown stationary base body G which is designed as a frame and can be attached, for example, to the floor of a production hall.

The base body carries a feed unit A that is connected to it in a stationary position, with the aid of which products P are conveyed in the conveying direction X. A processing unit B is arranged directly downstream of the feed unit A. The processing unit B comprises a conveyor unit M, which is likewise designed to transport products P in the conveying direction X and, for this purpose, takes over the products P from the upstream feed unit A. The feed unit A and the conveyor unit M are each equipped with a revolving conveyor belt. The upper sides of the respective conveyor belts are aligned flush at the same height, and the conveyor belt of the conveyor unit M defines a conveying plane E on its upper side:

The processing unit B comprises a first processing means D₁ designed as a printing unit, which comprises an unspecified print head that is closely adjacent to the conveying plane E in the transverse direction Y. The printing unit extends both above and below the conveying plane E. In addition, the processing unit comprises a second processing means D₂ in the form of a camera, which is arranged at a close distance directly upstream from the first processing means D₁. The camera, too, is laterally closely adjacent to the conveying plane E and likewise extends both above and below it. Independently of the solution shown in these figures, it is also conceivable to arrange a camera downstream of another processing means, for example to check the quality of a print image that has just been applied upstream.

On the opposite side of the conveyor unit M, as seen in the transverse direction Y, an auxiliary means is provided in the form of a guide element H_{F} having a guide face F that extends essentially in an X-Z plane. The element serves to guide or stabilize a product P in the transverse direction Y while it is being captured by the camera D₂ and printed on by the printing unit D₁. The guide element H_{F} is thus associated with both the camera D₂ and the printing unit D₁ in order to support both processing means during the respective processing.

The position of the guide element H_{F} can moreover be freely adjusted in the transverse direction Y relative to the conveyor unit M or, respectively, the processing means D₁ and D₂, and can be fixed in place by means of two unspecified clamping rails. The guide element can also be pushed so far in the direction of the printing unit or, respectively, the camera that it is not positioned laterally to but above the conveying plane E.

The processing unit B, which includes the processing means D₁, D₂, the conveyor unit M and the guide element H_{F}, is connected to a linear guide L, which is actuated manually by means of a handwheel, in such a way that the processing unit B is freely displaceable in the transverse direction Y relative to the base body G and thus also relative to the feed unit A. The processing unit B can optionally be fixable in any selected displacement position along the linear guide L by means of fixing means (not shown in detail), in order to prevent unintentional displacement. Alternatively, for example, a threaded spindle of the linear guide can provide the necessary fixing through sufficient friction or self-locking.

FIG. 1 shows how a product P is arranged approximately in the center of the feed unit A and fed to the conveyor unit M in this transverse position. This position is unfavorable, at least for processing with the printing unit D₁, since the print head will not reach the side surfaces of the product facing the printing unit when the product is conveyed on the conveying plane E. Printing is not possible in this way.

As can be seen in FIG. 2, the inventive displaceability of the processing unit B relative to the base body G or, respectively, the feed unit A, however, makes it possible to take over the product P in a modified transverse position that is advantageous for the printing process. For this purpose, the processing unit B was displaced by means of the linear guide L in the transverse direction Y by an offset ΔY such that the product P reaches the conveyor unit M at the edge of the conveyor belt or, respectively, the conveying plane E and can be transferred to it in this way. Then the product side to be printed on reaches the print head at a close distance as required for printing.

FIGS. 3 and 4 illustrate the principle of the invention in a simplified schematic top view of the conveying plane E. FIG. 3 shows the case in which a product P can be transferred from the feed unit A to the conveyor unit in the correct transverse position, namely at the left edge of the feed unit A, as viewed in the conveying direction, in order to be able to print on the product with the printing unit D₁. It is thus not necessary to move the processing unit B transversely relative to the base body G or, respectively, the feed unit A.

FIG. 3 also shows that the guide element H_{F} has been pre-positioned and fixed with its guide face F in the transverse direction Y in such a way that the products P are guided laterally and with little clearance past the print head of the printing unit D₁ as they are conveyed onwards and processed.

The camera provided as a further processing means D₂ was aligned and fixed in the transverse direction Y by means of positioning means (not shown in detail), such that the product P, or a section of the product to be detected by the camera, lies in the focusing area of the camera.

FIG. 4, on the other hand, shows the case in which the product P is introduced to the processing unit B at the right edge of the feed unit A, as viewed in the conveying direction. In order to transfer the products to the conveyor unit M in the transverse position shown in FIG. 3 and to be able to process them there, the processing unit B was shifted, in accordance with the invention, relative to the base body G or, respectively, the feed unit A by the offset ΔY, so that the product P can now be transferred in a straight line to the conveyor unit and be processed there at a predetermined distance or, respectively, a distance necessary for this purpose.

FIG. 5 shows an alternative embodiment of the invention in a simplified representation, with recurring reference signs corresponding to the respective explanations provided above. The figure shows a processing device T with a feed unit A, a processing unit B arranged downstream thereof, and a discharge conveyor (not shown in detail) arranged, in turn, downstream from the latter. Unlike the feed unit A and the discharge conveyor, the processing unit B can again be displaced in the transverse direction Y relative to the base body G. An inspection device D₂ in the form of a camera is arranged laterally next to and just above the conveying plane E and serves here as a processing means for detecting the products P supplied to the conveying plane E using image recognition means. In the transverse direction Y, on the other side of the conveying plane E opposite the camera, there is an auxiliary device in the form of a light shield Hi that interacts with the camera. This at least partially blocks the spread of the light emitted by the lighting required for the camera to the surrounding area, since it is usually a flash light that disturbs the operator.

According to the invention, the camera D₂, the conveyor unit M, and the light shield H_{L} jointly form part of the processing unit B and, as such, are movable in the transverse direction Y in such a way that the products P supplied by the feed unit A are located in the focusing area of the camera.

FIG. 6 shows a simplified representation of a product P during an X-ray inspection, looking along the conveying direction X. For this purpose, an auxiliary means H_{RQ} designed as an X-ray source directs X-rays in a fan-like manner in the transverse direction Y onto a processing means designed as an X-ray detector D₃. The X-rays penetrate the product P transported on the conveyor unit M in a Y-Z plane and reach the X-ray detector D₃ with varying intensity, depending on the radiolucency of the product along the respective X-ray beam. To ensure that the entire product is fully radiographed, the processing unit with the conveyor unit M was moved in the transverse direction Y so that the product, instead of being conveyed at an unfavorable transverse position Y₀, is conveyed at position Y, which is suitable for optimal irradiation. In order to make optimal use of the size of the detector D₃, its Y-distance from the X-ray source H_{RQ} was previously adjusted. Thus, the product is fully radiographed, and the X-rays reach the detector D₃ over its entire available vertical detection area.

### LIST OF REFERENCE SIGNS

A feed unit
B processing unit
D, D* processing means
D₁ printing unit
D₂ camera
D₃ X-ray detector
E conveying plane
F guide face
G base body
H auxiliary element
H_{RQ} X-ray source

H_{F} guide element
H_{L} light shield
L linear guide
M conveyor unit
P product
T processing station
X conveying direction
Y transverse direction
Y₀ unsuitable transverse position
Y₁ suitable transverse position
Y_{DH} distance between processing means D and auxillary means H
Z height direction
ΔY offset in transverse direction Y

1. A processing station (T) for conveying and processing discrete products (P) in a product stream, wherein the processing station (T) extends in a conveying direction (X), a transverse direction (Y) orthogonal thereto and a height direction (Z) orthogonal to these two directions, and wherein the processing station has a base body (G) that is positioned in a fixed position on a frame in regular operation,
a) wherein the processing station (T) has a processing unit (B) that in turn comprises a conveyor unit (M), at least one processing means (D) and at least one auxiliary means (H) associated with the at least one processing means,
b) wherein the conveyor unit (M) is designed to transport products (P) in the conveying direction (X) along a conveying plane (E) formed by the conveyor unit (M),
c) wherein the processing means (D) is designed to process a product (P) while it is being conveyed or temporarily halted by the conveyor unit (M), and wherein the processing is carried out using the auxiliary element (H) associated with the respective processing means (D),
d) the at least one auxiliary element (H) and the at least one processing means (D) each extend at least partially above the conveying plane (E), and
e) the at least one processing means (D) and the at least one auxiliary element (H) associated therewith for processing the product (D) are
e₁) fixed to the processing unit (B) on two sides of a product (P) conveyed by the convey unit (M), which sides are opposite one another in the transverse direction (Y), and
e₂) displaceable together with the conveyor unit (M) and relative to the base body (G) in the transverse direction (Y) (relative movement) in order to receive a product (P) to be fed to the processing unit (B) at a predeterminable Y-position of the conveying plane (E) or of the convey unit (M) and to convey that product (P) through the area between the auxiliary element (H) and the processing means (D).

2. The processing station (T) according to claim 1, further comprising a feed unit (A), which is stationary in regular operation and arranged upstream of the processing unit (B), designed to convey products (P) that are conveyed lying on it in the conveying direction (X) and feed them to the conveyor unit (M) of the processing unit (B).

3. The processing station (T) according to claim 1, wherein the processing unit (B) is carried by an automatically or manually operated guide (L)—in particular a linear guide (L)—that is connected to the base body (G), which enables the relative movement of the processing unit (B) in the transverse direction (Y).

4. The processing station (T) according to claim 1, wherein the at least one processing means (D) is designed as
a) a marking unit, in particular as a printing unit (D1), in order to print on a side surface of a product (P), preferably on the side surface facing away from the auxiliary element (H), or
b) an inspection unit (D2), in order to detect
b₁) a feature characterizing the product (P), in particular a marking applied to the product (P), or
b₂) a product property that can be detected using detection means, in particular an inhomogeneity or a foreign body.

5. The processing station (T) according to claim 1, wherein the at least one auxiliary element (H) is designed as
a) a guide element (H_{F}) having a guide face (F) in order to guide a product (P) conveyed on the conveying plane (E) along the guide face (F) in the transverse direction (Y) at a defined Y-position, or
b) a light shield (H_{L}) or background lighting, or as a radiation source.

6. The processing station (T) according to claim 1, wherein at least one auxiliary element (H) comprises a further processing means (D*) according to claim 4.

7. The processing station (T) according to claim 1, wherein at least one processing means (D) and/or one auxiliary means (H) is manually or automatically adjustable and fixable in the transverse direction (Y) or the height direction (Z) in order to be able to guide or process products (P) of different widths or heights.

8. The processing station (T) according to claim 1, wherein
a) a housing at least partially encasing the at least one processing unit (B), or
b) a control and/or evaluation unit or display unit or control cabinet predominantly associated with the at least one processing unit (B)
is/are connected to the base body (G) in a stationary manner.

9. A method for processing a product (P) by means of a processing station (T) according to claim 2, comprising the following steps:
10) positioning the processing unit (B) in the transverse direction (Y) relative to the feed unit (A) based on the position in which the product (P) is placed on the feed unit (A) at the moment of transfer to the conveyor unit (M), and
20) conveying at least one product (P) by means of the feed unit (A) and automatic transfer of the product (P) to the conveyor unit (M) of the processing unit (B), with subsequent conveying of the product (P) in the conveying direction (X) and processing of the product (P) by the processing means (D) and the auxiliary means (H) associated therewith.

10. The method according to claim 9, wherein the following step is carried out before method step 10):
05) positioning the at least one processing means (D) and of the auxiliary means (H) associated therewith in the transverse direction Y relative to the conveyor unit (M) in accordance with a product (P) to be conveyed, in particular setting of a distance (Y_{DH}) in the transverse direction (Y) between the at least one processing means (D) and the auxiliary means (H) associated therewith.

11. The method according to claim 5, wherein the guide face (F) extends essentially in the conveying direction (X), wherein the processing unit (B) is positioned in the transverse direction (Y) such that
i) a section of an outer surface of the product (P) is aligned with the guide face (F), so that the product (P) is guided laterally by the guide element (HF) after it has been transferred to the processing unit (B), or
ii) a section of an outer surface of the product (P), after it has been transferred to the processing unit (B), occupies a predeterminable Y-position on the conveying plane (E) as required for the processing with the processing means (D).

12. The method according to claim 9, wherein the processing unit (B) is positioned in the transverse direction (Y) in such a way that, after the transfer of the product (P) to the processing unit (B), the product (P) or a marking arranged thereon occupies a Y-position on the conveying plane (E) in such a way that
a) an area of the product (P) to be captured by an inspection unit in the form of a camera (D₂) lies in the focusing range of the camera,
or
b) the X-rays emanating from an X-ray source (H_{RQ}) radiograph the entire product (P).
